(19) United States
(12) Patent Application Publication
(10) Pub. No.: US 2026/0365435 A1
(43) Pub. Date: Nov. 19, 2026

(54) SMALL LOT MATERIAL MANAGEMENT

(71) Applicant: FORD GLOBAL TECHNOLOGIES, LLC, Dearborn, MI (US)

(72) Inventor: Andrew Blatt, Livonia, MI (US)

(21) Appl. No.: 19/206,112

(22) Filed: May 13, 2025

(51) Int. Cl. B65G 1/137; B65G 1/04; B65G 1/06

(52) U.S. Cl. CPC B65G 1/1378; B65G 1/0485; B65G 1/065

(57) ABSTRACT

A manufacturing sorting and delivery system is disclosed for automating the distribution, transport, and retrieval of components within a facility. Components are dispensed in volume, without counting, into designated slots of a tote based on image data associated with the tote or its slots. The totes are conveyed between storage and operator stations via conveyors, and received at an inclined rack that allows ergonomic access without removing the tote.

### TECHNICAL FIELD

Various embodiments relate to a computer-implemented logistics apparatus and method for storing assembly components in totes. The embodiments have applicability in increasing efficiency in assembly lines.

### BACKGROUND

Assembly components are generally stored in bulk boxes which are stored in flow racks proximate to assembly line positions. Assembly line operators may need to manually retrieve specific materials from various bulk boxes. Operators may be responsible for breaking down bulk boxes once they are emptied of assembly components.

### BRIEF DESCRIPTION OF THE DRAWINGS

FIG. 1 is an example tote having slots.

FIG. 2 is an example tote filling assembly.

FIG. 3 is an example diagram illustrating a conveyor assembly for filling totes with assembly components.

FIG. 4 is an example manufacturing line floor including a conveyor system for totes.

FIG. 5 is an example tote presentation rack.

### SUMMARY

A manufacturing sorting and delivery system is designed to automate the distribution and handling of components within a facility. It includes one or more dispenser systems that supply volumes of components—such as fasteners—into designated slots of a tote, without counting the individual components. The volume delivered to each slot is determined using image data associated with the tote or its slots. As the tote moves past the dispensers, it accumulates different components in each slot. These totes are then transported by one or more conveyors—some of which may be suspended—either to storage or to an operator station. At the station, a rack with an inclined shelf allows totes to slide into position for ergonomic access, enabling operators to retrieve components without removing the tote from the rack. The system may also include a manual fill station accessible via a conveyor path, and a vision system capable of recognizing unique tote and slot identifiers. This data enables one or more controllers to dynamically assign fill volumes based on detected identifiers. The totes themselves are organized with dividers extending from their base to form separate component slots.

A method of manufacture involves an automated process for managing component distribution using totes. It begins with automatically filling a designated slot within a tote with a volume of components without individually counting them. This fill volume is determined based on image data associated with the tote or specific slot. Once filled, the tote is transported to and from storage among other totes, ultimately arriving at an operator station. The method may further include reading an identifier to retrieve the necessary image data for determining the fill volume. Upon delivery to the operator station, the tote may be positioned on a rack.

A manufacturing control system is designed to automate and streamline component handling through intelligent coordination of dispensing, transport, and operator access. It includes one or more controllers programmed to dispense varying volumes of components—without counting—into individual slots of a tote, with the dispensing based on image data linked to the tote or its slots. The system manages the movement of the tote to and from storage and ensures its delivery to a rack at an operator station. This rack is configured to allow an operator to retrieve components directly from the tote without removing it from the rack. Additionally, the controllers can scan identifiers located on the tote or within the slots to access the image data necessary for accurate volume dispensing.

### DETAILED DESCRIPTION

Manufacturing systems are configured for efficient assembly of products such as vehicles. Such manufacturing systems typically include a plurality of manufacturing positions arranged along an assembly line. Respective manufacturing positions may comprise an operator which assembles assembly components onto the product at a respective stage of assembly. The operator may be a human operator or may be a controller actuated operator such as a robotic arm assembly. Operators may be configured to assemble components of a product using various assembly components including fastener, computer modules, etc. In some situations, operators may be supplied with assembly components stored in containers which are in turn stored on flow racks. When the operator has used up assembly components in the manufacturing process, the operator may need to stop assembly on the manufacturing line in order to retrieve additional assembly components from the flow rack. Additionally, as assembly components are retrieved from the containers of in the flow racks, the containers may be removed from the flow rack leaving unused space in the flow rack. In this way, the flow rack may occupy space in the manufacturing floor without providing a benefit.

Detailed embodiments are provided below. These embodiments, however, are intended solely as examples and may take various alternative forms and configurations. The accompanying figures are not drawn to scale. Certain features may be exaggerated, minimized, or omitted to highlight specific details of particular components. Consequently, the structural and functional details described herein are not to be interpreted as limiting but rather as illustrative examples to guide those skilled in the art in applying the described concepts in different ways.

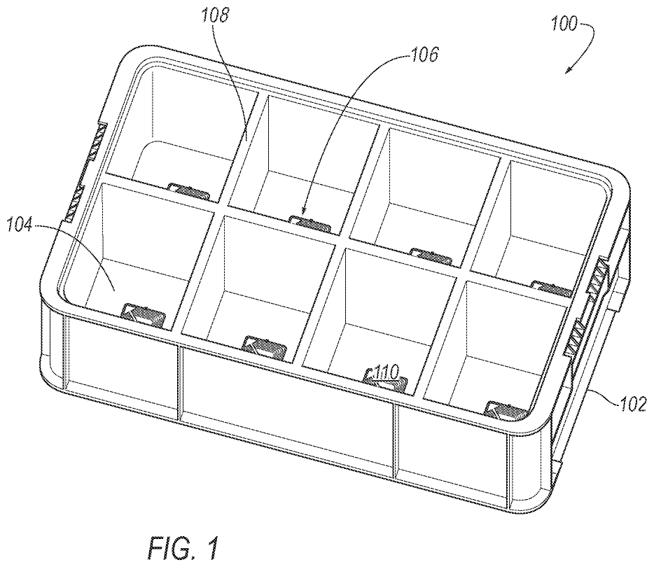

FIG. 1 illustrates a tote box 100 (or “tote 100”). The tote 100 may be comprised of an outer wall 102 and a base 104. The tote 100 may comprise a plurality of slots 106 defined by dividers 108. The dividers 108 may extend vertically from the base 104 and isolate each of the slots 106. That is, the dividers 108 function to separate each of the slots 106 such that when materials such as assembly components are disposed within the slots 106, the assembly components stay within the slot 106 in which the assembly components were disposed and do not spill into adjacent slots 106. Therefore, the dividers 108 keep specified pluralities of assembly components separated into respective pluralities. Each of the plurality of slots 106 may have an identifier 110 disposed in the slot 106. The identifier 110 may be any device or pattern which may be used to identify any one of the plurality of slots 106. For example, the identifier 110 may be a bar code which may be scanned by a bar code reader and identified based on the unique barcode pattern. The identifier 110 may also be a radio frequency identification (RFID) tag. As an example, a controller may be supported by the system and configured to receive the unique identification of each of the slots 106 based on each of the identifiers 110 associated with each of the slots 106. In this way the controller may differentiate each one of the slots 106 from the other slots 106.

The tote box 100 may be manufactured by injection molding of a specified material (e.g., plastic) such that the outer wall 102 and base 104 are joined together and may form a continuous surface. The dividers 108 may also be formed by injection molding along with the outer wall 102 and base 104 such that the outer wall 102, base 104, and dividers 108 form a continuous surface. In another embodiment, however, the dividers 108 may be separate from the outer wall 102 and the base 104. In such an example, the dividers 108 may be fitted to the outer wall 102 after the tote box 100 has been manufactured. The outer wall 102 and/or the dividers 108 may have a plurality of slots configured to fit together such that the dividers 108 form a grid pattern when disposed within the tote box 100. As another example, the dividers 108 may be manufactured separately from the tote box 100 into specific configurations (e.g., all slots 106 being the same size, some slots 106 being varied sizes, any combination of slot sizes, etc.). The dividers 108 may be configured to be disposed into the tote box 100 in any suitable manner to define the plurality of slots 106. As a further example, during manufacturing of the dividers 108, the dividers 108 may be specified to have dimensions (e.g., distances from other dividers 108, intersection points between dividers 108, etc.) such that specific layouts of the slots 106 are achieved. FIG. 1 depicts a layout in which the dividers 108 define eight slots 106 of equal volume. However, it will be understood that the dividers 108 may be alternatively configured to achieve various layouts of the slots 106 including some of the slots 106 being larger than other of the slots 106.

The tote box 100 may further include handles (not shown) configured to be grasped by an operator (e.g., a user or a controller actuated device) for streamlined lifting and transport of the tote box 100.

The base 104 and outer wall 102 may define a top opening of the tote wherein assembly components are disposed in order to be stored within the tote box 100. Each respective slot 106 may further comprise a top opening which, together, comprise the top opening of the tote box 100. The top opening of the tote box 100 may be covered by a detachable top (e.g., a lid or cover). The detachable top may be fitted onto the tote box 100 so as to prevent foreign objects from entering the tote box while the top is fitted to the tote box 100. The detachable top may also be locked to the tote box 100 so as to hinder removal of assembly components from the tote box when the detachable top is fitted to the top opening. The detachable lid may be fixed to the tote box 100 by any known means such as hooks, clamps, fitted channels, etc.

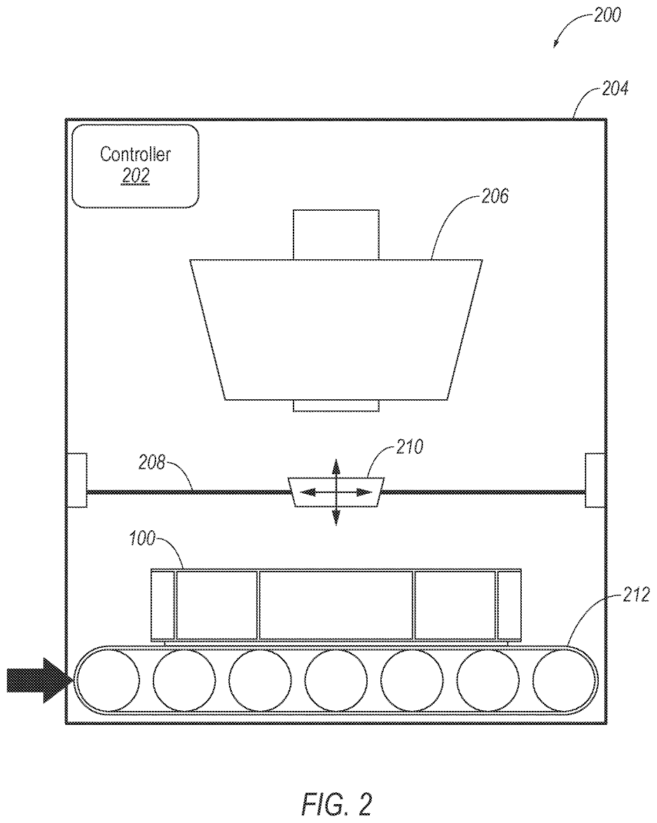

FIG. 2 illustrates a filling assembly 200 for disposing assembly components into the tote box 100. The filling assembly 200 includes a controller 202, a frame 204, a material separation device 206 supported by the frame 204, a computer numerical controller (CNC) tote handling device 208, an assembly component dispensing device 210, and a conveyor 212 configured to transport the tote box 100 along the path defined by the conveyor 212, which may travel underneath the dispenser 210.

The controller 202 may be one of a plurality of controllers or may refer to an arrangement of controllers. The controller 202 may be, for example, a computer having a processor and a memory which may store instructions executable by the processor to carry out specified functions. The controller 202 may coordinate operations of modules, machines, subsystems, etc. associated with the manufacturing line. In this example the controller actuates the filling assembly 200 based on stored instructions or received input (e.g., from a sensor as described in further detail below). In other examples, the controller 202 may be part of a larger grouping of controllers which coordinate different subsystems across the manufacturing line. The controller 202 is in communication with a plurality of manufacturing subsystems of the manufacturing line and is configured to coordinate functionality of manufacturing process. The controller 202 may be a facility-based computing system that includes one or more controllers that communicate via a serial bus (e.g., controller area network (CAN)) or via dedicated electrical conduits). The controller 202 generally includes any number of microprocessors, ASICs, ICs, memory (e.g., FLASH, ROM, RAM, EPROM and/or EEPROM) and software code to co-act with one another to perform a series of operations. The controller 202 also includes predetermined data, or “lookup tables,” that are based on calculations and test data, and are stored within the memory. The controller 202 may communicate with various systems and/or other controllers over one or more wired or wireless connections using common bus protocols (e.g., CAN and LIN). Used herein, any reference to “a controller” refers to one or more controllers.

The controller 202 may communicate with various sensors and actuators via an input/output (I/O) interface that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. Although not explicitly illustrated, those of ordinary skill in the art will recognize various functions or components that may be controlled by a controller within each of the subsystems identified above.

The filling assembly 200 may further include an optical sensor (not numbered). The optical sensor may be a camera configured to capture images and/or measured parameters of an area included in the sensor's field of view. The optical sensor may, for example, be supported by the frame 204 and configured to collect data about the tote box 100 and transmit the data to the controller 202. The data may include images of the identifiers 110 for the purpose of the controller 202 identifying the specific slot 106 associated with the identifier 110. The data may include images of a volume of assembly components disposed within any one of the slots 106. In such an example, the assembly components may obstruct the identifier 110 from the field of view of the optical sensor. In such a scenario, the identifier 110 may be a device (e.g., RFID tag) configured to send a unique communication to the controller 202 identifying the identifier 110 and therefore the slot 106 associated with the identifier. Based on the visual data from the optical sensor, the controller 202 may approximate a general (e.g., non-exact) number of individual assembly components disposed in any one of the slots 106. The controller 202 may approximate the number of assembly components in the slot 106 by measuring a volume of the assembly components disposed in the slot 106. The controller 202 may, in turn, measure the volume of the assembly components in the slot 106 based on the visual data from the optical sensor.

The controller 202 may approximate the number of assembly components disposed in the slot 106, for example, based on an average height of the volume of assembly components disposed in the slot 106. In such an example, the controller 202 may receive visual data from the optical sensor. Based on the visual data, the controller 202 may determine that the average height of the volume of assembly components disposed in the slot 106 is ten centimeters from the top of the dividers 108 which define the slot 106. The average height may be determined by approximating the average between the lowest measurable point of the assembly components in the visual data and the highest measurable point of the assembly components in the visual data (highest and lowest being relative to the depth of the slot 106). The controller 202 may retrieve parameters associated with the slot from memory based on the identifier 110 associated with the slot 106 such as a height of the slot 106 (e.g., the distance from the base 104 to the top of the divider 108). If, for example, the height of the slot is forty centimeters, the controller 202 determines that the average height of the volume of components is thirty centimeters. Based on further slot parameters (e.g., width and length of the slot) in combination with the average height of the assembly components, the controller 202 can calculate the volume of the assembly components in the slot 106.

The controller 202 may estimate a number of assembly components disposed in the slot 106 based on the volume calculated as described above. Once the controller 202 has approximated the volume of the assembly components (e.g., based on the average height of the assembly components disposed in the slot 106) the controller 202 may approximate the number of assembly components based on stored parameters associated with the specific assembly component. As mentioned above, the tote box 100 is intended to store one type of assembly component in each of the slots 106 (e.g., a first slot has a plurality of a first specified fastener whereas a second slot has a plurality of a second specified fastener). The controller 202 may determine the specific assembly components disposed in the slot 106 based on the visual data by utilizing a neural network trained on test images to identify assembly components. The controller 202 may alternatively determine the specific assembly components disposed in the slot 106 based on stored parameters associated with the slot 106 based on the identifier 110 (e.g., the controller 202 may associate assembly component A with identifier A and assembly component B with identifier B). The controller 202 may store parameters about specific assembly components such as dimensions including height, width, weight, etc. Based on the parameters, the controller 202 may calculate the number of assembly components in the slot 106 by performing calculations to determine how many of the specific assembly component may fit in the calculated volume based on the dimensions of each assembly component when randomly disposed into the slot 106. Again, the controller 202 may utilize a neural network trained to perform such calculation as is known.

Once the controller 202 has estimated the approximate number of specified assembly components disposed in the slot 106 (e.g., as described above) the controller 202 may determine whether to actuate the separation device 206 and dispenser 210 to dispose additional assembly components into the slot 106. Additionally, the controller 202 may determine whether to actuate the separation device 206 and dispenser 210 to dispose assembly components into the slot 106 when the controller 202 determines that the slot 106 is empty (e.g., contains no assembly components). The controller 202 may determine whether to dispose additional assembly components in the slot 106 as well as what specific assembly components to dispose based on stored parameters associated with the slot's identifier 110. For example, a user such as a manufacturing line operator may specify types of assembly components and approximate numbers of the assembly components which are required at an assembly station on the manufacturing line in order for the station's operator to complete an assigned manufacturing task. The user may identify specific assembly components and numbers of components for each of the identifiers 110 associated with each of the slots 106. Alternatively, the user may specify required assembly components to the controller 202, and the controller 202 may then retrieve a plurality of stored lookup tables to determine how to efficiently arrange the assembly materials in a single box tote 100.

Table 1 is an example lookup table specifying manufacturing lines, assembly stations on the manufacturing lines, what assembly component is required at each station, the quantity required, what tote group the component is disposed in, the specific slot 106 which contains the component, and the overall number of components required by all stations.

TABLE 1

| | | | Quantity | Tote | | |
|---|---|---|---|---|---|---|
| Line | Stations | Component No. | Needed | Group | Slot | Total |
| C1 | 5 | ML34-5577883 | 2 | 20 | 1 | 6 |
| C1 | 7 | ML34-5577883 | 4 | 20 | 1 | |
| C2 | 23 | ML34-9876234 | 7 | 22 | 1 | 7 |
| C2 | 26 | ML34-0006523 | 3 | 22 | 2 | 9 |
| C2 | 27 | ML34-0006523 | 6 | 22 | 2 | |
| C3 | 9 | ML34-6722229 | 10 | 24 | 1 | 10 |
| C3 | 18 | ML34-7844452 | 5 | 24 | 2 | 5 |

The material separation device 206 and the dispenser 210 are configured to operate in combination to dispose the assembly components into the slots. That is, the material separation device 206 may be any device or system configured to dispose assembly components (e.g., a spiral feeder, a hopper, a trapdoor bin, etc.) as is known. The dispenser 210 may be any device configured to receive assembly components from the material separation device 206. As an example, the material separation device 210 may have an opening which may receive assembly components of various types. The material separation device 210 may include a sorting mechanism. The sorting mechanism may be a plurality of chutes configured to receive only one specific assembly component, a controller actuated identification system which may include actuatable gates or surfaces for diverting identified assembly components into associated compartments, or any known means for sorting. The material separation device 206 may then output the assembly components to the dispenser 210 to be dispensed into the slots 106. The material separation device 206 may be connected to the dispenser 210 by any means which enables the assembly components to be moved from the separation device 206 to the dispenser 210 such as a chute, ramps, etc. (not shown). The dispenser 210 may be supported by a moveable surface which is supported by the frame 204 (not shown) such that the controller 202 may actuate the moveable surface to position the dispenser 210 over specific slots 106. The moveable surface may be a series of tracks, pistons, rollers, etc.

The controller 202 may actuate the material separation device 206 to output specific assembly components to the dispenser 210 based on stored instructions such as the lookup tables described above. Based on a request for assembly components, the controller 202 may, after determining that the tote box 100 will be transported to the station that made the request, actuate the dispenser 210 to be disposed over a specific one of the slots 106 that has an identifier 110 identifying the specific assembly component requested (e.g., via the moveable surface). The controller 202 may then actuate the material separation device 206 to output the specific assembly component such that the assembly component travels through the dispenser 210 into the slot 106.

The controller 202 may retrieve specific ones of the tote boxes 100 based on the request for additional materials and the lookup tables. The controller 202 may retrieve the tote boxes 100 by actuating the CNC tote handling device 208 to lift the tote box 100 from storage and place it on the conveyor 212 which is configured to transport the tote box 100 to the filling assembly 200 and beyond. The CNC tote handling device 208 may be any computer numerical controller configured to contact the tox box 100 in such a way to retain the tote box 100 (e.g., via arms, forks, etc.). As an example, the CNC tote handling device 208 may be a robotic arm supported by tracks and having grips configured to be received by handles of the tote box 100 such that the CNC tote handling device 208 has six degrees of movement and may be actuated by the controller 202 to retrieve the tote boxes 100 from storage racks, place the tote boxes 100 on the conveyors 212, retrieve the tote boxes from the conveyors 212, and return the tote boxes 100 to storage racks.

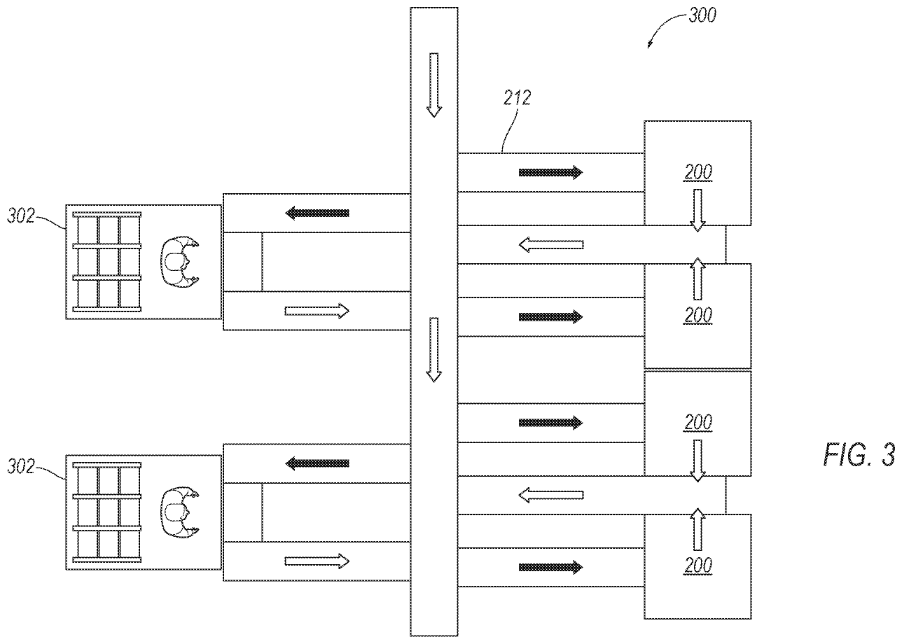

FIG. 3 illustrates a top down view of an example conveyor layout 300 for filling tote boxes manually and automatically. As is shown, tote boxes may be transported to auto filling assemblies 200 such that the filing assemblies 200 may dispose assembly components to the slots of the tote boxes according to instructions of the controller. The controller may also redirect tote boxes to manual filling stations 302. Manual filling stations are stations along the conveyor 212 configured for operators (e.g., human users, CNC robots, etc.) to dispose assembly components into the slots. The manual filling stations 302 may have storage areas containing assembly components which have parameters that restrict the practicality of usage in filling assemblies 200 (e.g., assembly components that are too large to be disposed by filling assemblies 200). The controller may actuate the conveyor 212 to route tote boxes to manual filling stations 302 when the controller determines, as described above, that the tote box requires additional assembly components which are specifically disposed by the manual filling stations 302.

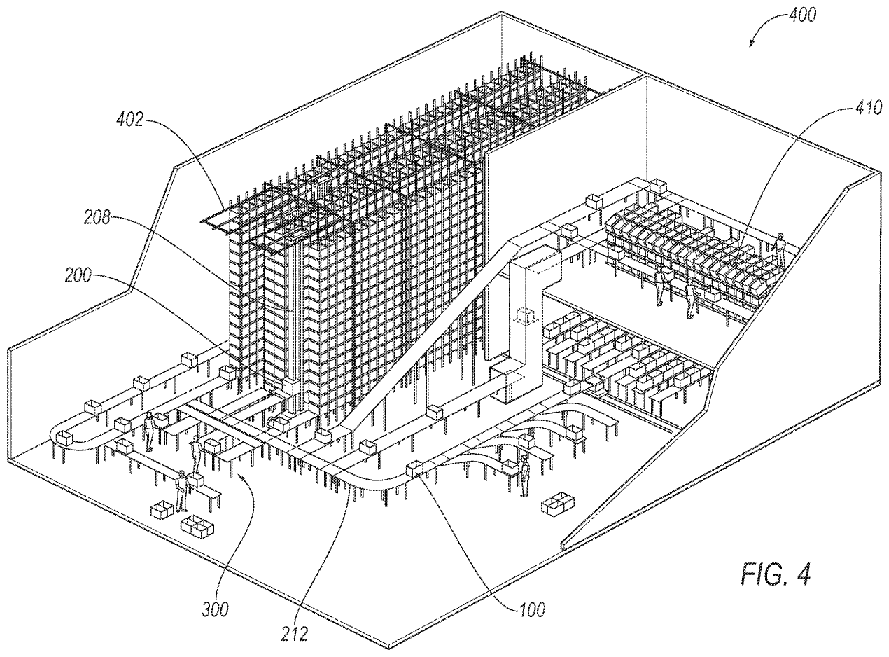

FIG. 4 illustrates an example conveyor system 400 including the conveyor layout 300. The conveyor system 400 may be on a floor of a manufacturing facility. The conveyor system 400 may be separate from a manufacturing line (e.g., housed in another building) or integrated into the manufacturing line. In this example, the conveyor system 400 is integrated into a manufacturing line 410. The conveyor system 400 includes pluralities of tote boxes in various stages of storage, filling, and usage. The conveyor system 400 includes storage racks 402 which are arranged vertically so as to decrease space taken up on the floor for the purposes of tote storage. The conveyor system includes the filling assemblies 200 having the CNC tote handling devices 208 which, as described above, are configured to retrieve tote boxes from the storage racks 402. In this example, the CNC tote handling devices 208 are arms supported by tracks configured to have six degrees of movements in order to retrieve any of the plurality of tote boxes on the storage racks 402. The conveyor system 400 also includes the conveyor assembly 300 positioned proximate to the storage racks 402 such that when the CNC tote handling device 208 retrieves the tote box the controller may then actuate the conveyor 212 and filling assemblies 200 to dispose the assembly components in the slots. Any of the conveyors 212 may be supported by legs or suspended from the ceiling and/or raised supports.

The manufacturing line 410 may be any assembly line having stations with operators that perform functions which are part of the assembly process as is known. As an example, the manufacturing line 410 may be a vehicle manufacturing line. Operators on the manufacturing line may be human or automated. Operators may request additional assembly components as necessary in order to complete their assigned tasks on the manufacturing line. Requests for additional assembly components may be input to the controller via wired or wireless communication (e.g., in the case of automated operators) or via a user interface. Operators may have an associated station on the manufacturing line and the controller may reference stored parameters (e.g., associated tote boxes and assembly components) associated with the operator and station in order to actuate the CNC tote handling device 208 to retrieve a tote box which may be associated with the station, actuate the tote filling station to dispose assembly components in the slots which are associated with the station, and actuate the conveyors 212 to route the tote boxes to the station that made the request.

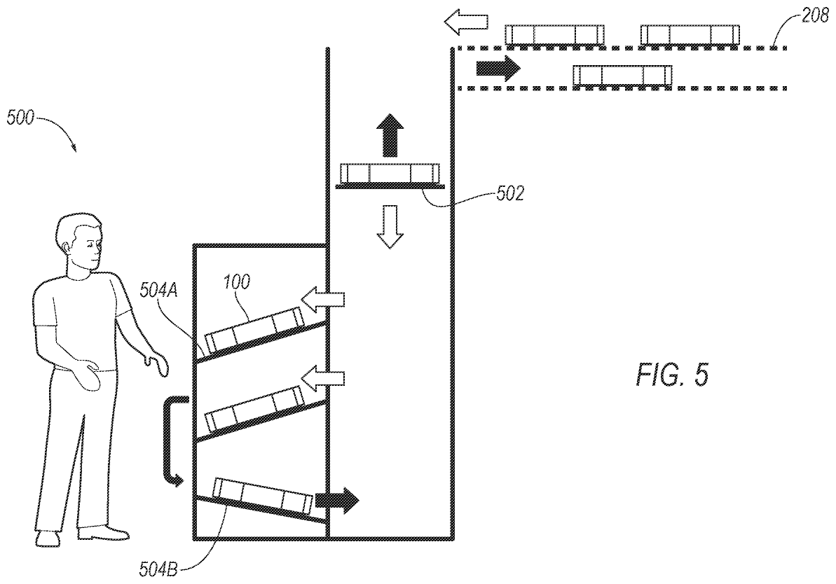

FIG. 5 illustrates a tote presentation rack 500. The tote presentation rack 500 may be associated with the manufacturing line such that the tote presentation rack 500 presents tote boxes 100 containing assembly components to operators on the manufacturing line. For example, the tote presentation rack 500 may be positioned behind an operator or in front of the operator across the conveyor 208 as the operator operates on the manufacturing line such that the operator may retrieve assembly components from tote boxes 100 on the tote presentation rack 500 without needing to leave their station on the manufacturing line.

The tote presentation rack may include a lift 502 such as an elevator, a set of elevating arms, etc. The tote presentation rack 500 may further include a plurality of inclined shelves 504 (504A, 504B, etc.) configured to guide the tote box 100 towards the operator and away from the operator depending on whether the inclined shelf 504i is inclined to or away from the operator. The inclined shelves 504 may include devices to expedite travel of the tote boxes 100 such as rollers. The lift 502 is configured to retrieve the tote boxes 100 from the conveyor 208, descend to the manufacturing line with the tote box 100, dispose the tote box 100 onto one of the plurality of inclined shelves 504 inclined towards the operator, retrieve the tote boxes 100 from the inclined shelves 504 inclined away from the operator, ascend with the tote box 100, and dispose the tote box 100 on the conveyor 208. The conveyor 208 may be one or more conveyors 208 configured to transport the tote box 100 to and from the presentation rack 500.

The inclined shelves 504 allow the controller to actuate the conveyor system to transport requested assembly components to operators. After the lift 502 disposes the tote box 100 to the inclined shelf 504A the tote box 100 slides along the inclined shelf 504A until it reaches an end of the inclined shelf 504A where it may then be stationarily supported by, for example, a surface of the presentation rack 500 such as a lip. The operator may then retrieve assembly components from the slots 106 of the tote box 100 as required. Once the operator has utilized the assembly components and determines that the tote box 100 is no longer required, the operator may retrieve the tote box 100 from the inclined shelf 504A and dispose the tote box 100 on the inclined shelf 504B. The inclined shelf 504B may be positioned beneath the inclined shelf 504A. Once disposed on the inclined shelf 504B, the tote box 100 slides along the inclined shelf 504B until it reaches an end of the inclined shelf 504B where it is then retrieved by the lift and disposed onto the conveyor 208. From there the controller may actuate the conveyor 208 to transport the tote box 100 back to the storage racks or, alternatively, directly back to the filling station such that the tote box 100 is filled with further assembly components and is prepared for further usage at the manufacturing line.

Computing devices, like the controllers suggested above, generate commands that can be executed to carry out the processes outlined. These computer-executable commands may be compiled or interpreted from programs created using various programming languages and technologies, including, but not limited to, Java™, C, C++, Python, Julia, SCALA, Visual Basic, JavaScript, Perl, and HTML. Typically, a processor (e.g., a microprocessor) receives these commands from a memory or another computer-readable medium and executes them, thereby performing one or more processes, including those described herein. Such commands, along with other data, may be stored in files and transmitted through various computer-readable media. In computing, a file is generally a collection of data stored on a computer-readable medium, such as a storage drive or random-access memory.

A computer-readable medium (also referred to as a processor-readable medium) is any non-transitory (i.e., tangible) medium that provides data, including instructions, which can be read by a processor of a computing device. This medium can take many forms, including non-volatile media (e.g., storage drives) and volatile media (e.g., RAM). Instructions may also be transmitted through transmission media such as fiber optics, wired connections, or wireless communication systems, including internal system buses connected to the processor of a computing device. Common examples of computer-readable media include RAM, PROM, EPROM, FLASH-EEPROM, memory chips or cartridges, or any other medium that a computing device can read.

While exemplary embodiments have been described above, these embodiments are not intended to encompass all possible implementations. The language used in the specification serves as a description rather than a limitation, and various modifications may be made without departing from the spirit and scope of the subject matter described. Additionally, features from different embodiments may be combined to create further implementations within the scope of the claims.

What is claimed is:

1. A manufacturing sorting and delivery system comprising:
one or more dispenser systems each configured to supply a volume of components, without counting the components, to a tote having one of a plurality of slots designated for the one or more dispenser systems such that after the tote has travelled by the one or more dispenser systems the tote holds different of the components in each of the slots, wherein the volume is based on image data associated with the tote or slots;
one or more conveyors configured to transport the tote to storage with other totes, and to transport the tote from the storage to an operator station; and
a rack at the operator station configured to receive the tote from the one or more conveyors such that an operator can remove at least some of the different of the components from the slots without the operator having to remove the tote from the rack, and to feed the one or more conveyors the tote after the at least some of the different of the components have been removed from the slots.

2. The system of claim 1, wherein the rack includes an inclined shelf such that as the tote exits the one or more conveyors and enters the rack via the inclined shelf, the tote slides down the inclined shelf towards the operator.

3. The system of claim 1, wherein the rack includes an inclined shelf such that as the tote is placed on the inclined shelf, the tote slides down the inclined shelf towards the one or more conveyors.

4. The system of claim 1, wherein the one or more conveyors have a portion that passes through a manual fill station that is arranged to permit manual fill of at least one of the slots.

5. The system of claim 1, wherein at least some of the one or more conveyors are suspended conveyors.

6. The system of claim 1 further comprising a vision system arranged with the one or more dispenser systems and configured to detect an identifier on the tote.

7. The system of claim 1 further comprising a vision system arranged with the one or more dispenser systems and configured to detect identifiers in the slots.

8. The system of claim 7, further comprising one or more controllers configured to, for each of the slots, specify the volume according to the corresponding identifier.

9. The system of claim 1, wherein at least some of the different of the components are fasteners.

10. The system of claim 1, wherein the slots are defined by a plurality of dividers disposed in the tote and wherein the dividers extend away from a base of the tote and separate the slots.

11. A method of manufacture comprising:
automatically filling a slot of a tote with a volume of components, without counting the components, based on image data associated with the tote or slot such that after the filling, the slot contains the components; and
transporting the tote to and from storage with other totes such that after the transporting, the tote is located at an operator station.

12. The method of claim 11 further comprising reading an identifier to obtain the image data.

13. The method of claim 11, wherein the transporting includes delivering the tote to a rack at the operator station.

14. A manufacturing control system comprising:
one or more controllers programmed to dispense, without counting, different volumes of components into slots of a tote based on image data associated with the slots or tote, to convey the tote to and from storage, and to deliver the tote to a rack at an operator station arranged to permit an operator to remove at least some of the components without the operator having to remove the tote from the rack.

15. The manufacturing control system of claim 14, wherein the one or more controllers are further programmed to scan an identifier in one of the slots or on the tote to obtain the image data.
